(19) United States
(12) Patent Application Publication
(10) Pub. No.: US 2013/0097124 A1
(43) Pub. Date: Apr. 18, 2013

(54) AUTOMATICALLY AGGREGATING CONTACT INFORMATION

(71) Applicants: Jeremy de Souza, Seattle, WA (US); Mayerber Carvalho Neto, Kirkland, WA (US); Komal Kashiramka, Redmond, WA (US); Ladislau Conceicao, Redmond, WA (US); Gustavo Andrade, Bellevue, WA (US); Kumarswamy Valegerepura, Redmond, WA (US); Brendan Fields, Mercer Island, WA (US); Maithili Dandige, Sammamish, WA (US); Song Yue Yu, Redmond, WA (US); Narendranath Thadkal, Bellevue, WA (US); Govind Varshney, Sammamish, WA (US); Chris Gallagher, Snohomish, WA (US)

(72) Inventors: Jeremy de Souza, Seattle, WA (US); Mayerber Carvalho Neto, Kirkland, WA (US); Komal Kashiramka, Redmond, WA (US); Ladislau Conceicao, Redmond, WA (US); Gustavo Andrade, Bellevue, WA (US); Kumarswamy Valegerepura, Redmond, WA (US); Brendan Fields, Mercer Island, WA (US); Maithili Dandige, Sammamish, WA (US); Song Yue Yu, Redmond, WA (US); Narendranath Thadkal, Bellevue, WA (US); Govind Varshney, Sammamish, WA (US); Chris Gallagher, Snohomish, WA (US)

(73) Assignee: MICROSOFT CORPORATION, Redmond, WA (US)

(21) Appl. No.: 13/271,898

(22) Filed: Oct. 12, 2011

(51) Int. Cl. G06F 7/00

(52) U.S. Cl. 707/692; 707/E17.002

(57) ABSTRACT

A communication application automatically aggregates contact information. The communication application classifies contact information retrieved from data sources as either duplicate or complimentary contact information to a contact. The communication application aggregates the contact information and the contact into a unified contact object by eliminating the duplicate contact information and adding the complimentary contact information. The application presents the unified contact object through a user interface.

### BACKGROUND

Contemporary communication systems enable users to have a number of identities over various systems such as enterprise emails, personal emails, social networking exchanges, and comparable ones. Each of these systems may generate contact lists based on automatic processing of exchange information and/or manual input. A structure and content of contact information for distinct communication systems may be different depending on their infrastructure. Thus, a user may have a plurality of contact information for the same contact stored in each communication system they are associated with.

Increasingly, other applications are becoming capable of providing access to multiple communication systems for a user. For example, an electronic mail exchange application may be configured to send and receive emails from a variety of systems for a user managing the user's identities automatically. Because each communication system tends to have its own contact lists, it is a challenge for users to manage multiple contacts while using multiple communication clients. Discrepancies arise when a user attempts to communicate with a contact while accessing contact information from multiple sources. Contact information consolidation systems can be black boxes that hide the consolidation process from the user. Additionally, contact information consolidation services may not be sufficiently scalable to reach all applications and services utilized by a user. Consolidation services may be device dependent and may scale poorly to adverse use scenarios such as mobile and resource limited applications.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatically linking contact information. A communication application may address duplicate and complimentary contact information from data sources without interrupting user tasks. The application may remove duplicate contact information and aggregate complimentary contact information in a non-invasive process to the user experience. The communication application may automatically retrieve complimentary contact information and aggregate it to a unified contact object for presentation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a conceptual diagram illustrating a basic example of a system aggregating contact information;

FIG. 2 illustrates major components of an application aggregating contact information into a unified contact object according to embodiments;

FIG. 3 illustrates example aggregation processes provided by a communication application in a system according to embodiments;

FIG. 4 illustrates an example user interface displaying unified contact object in a system according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of aggregating contact information according to embodiments.

### DETAILED DESCRIPTION

As briefly described above, contact information may be automatically linked by a communication application. The application may determine match criteria for a contact associated with a contact list of a communication application. The application may determine duplicate contact information retrieved from at least one data service according to the match criteria. The application may access a data service of a data source such as a social networking application to retrieve the contact information. Next, the application may determine complimentary contact information retrieved from another at least one data service according to the match criteria. The application may retrieve contact information not found in the contact. The application may automatically aggregate the duplicate contact information, the complimentary contact information, and the contact into a unified contact object by eliminating the duplicate contact information and adding the complimentary contact information. The application may present the unified contact object to a user through a user interface of the communication application.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a contact may be a data set with elements such as identifiers to enable communication with another user. Contact may be part of a list of contacts presented to a user through a user interface of a communication application. Contact information may include the user's name, email address(es), telephone number(s), user-id(s), address(es), and similar identifiers. Contact information may also include dynamic information such as a user's presence information including availability and location. Contact information may be retrieved from an external or internal data source. Contact information may be retrieved during a bulk import, manual operations, and contact synchronization. Retrieved contact information may match the contact through common identifier(s) such as a user's whole name or partial name, user id, and email address. The contact information may be a duplicate of the contact or may have complimentary contact information not found in the contact.

Throughout this specification, the term “server” generally refers to a computing device executing one or more software programs typically in a networked environment. However, a server may also be implemented as a virtual server (software programs) executed on one or more computing devices viewed as a server on the network. Similarly, a “client” may refer to a computing device enabling access to a communication system or an application executed on a computing device enabling a user to access a networked system such as a social networking service, an email exchange service, and comparable ones. More detail on these technologies and example operations is provided below.

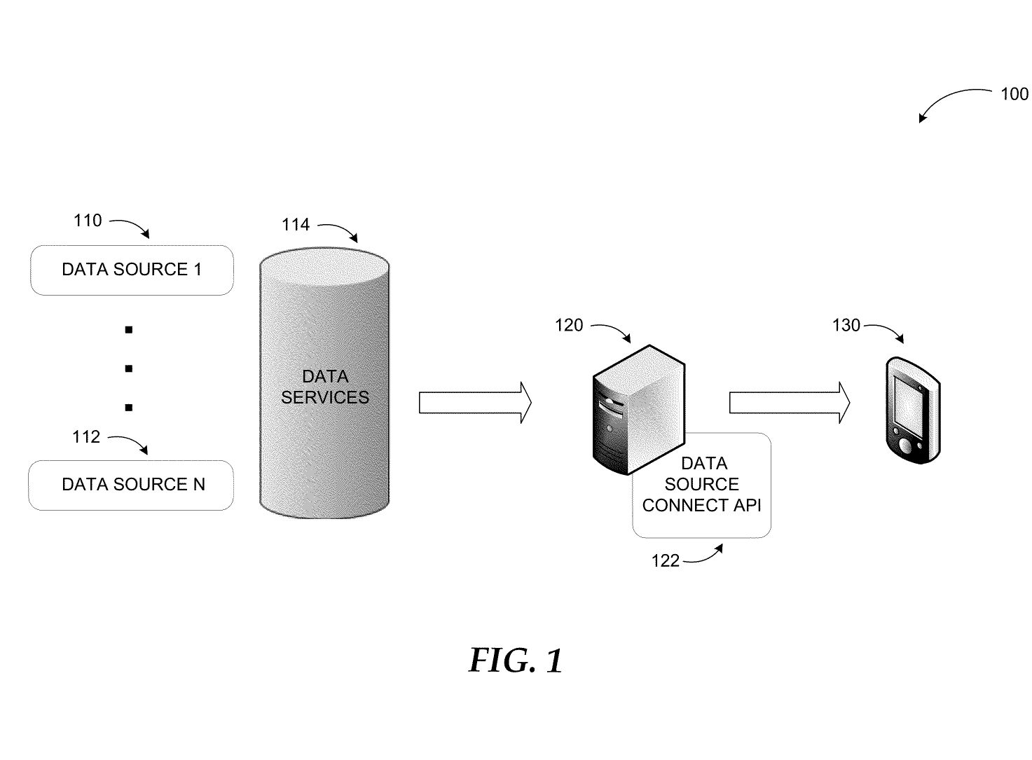

Referring to FIG. 1, diagram 100 illustrates a basic example of a system aggregating contact information. A communication application according to embodiments may automatically aggregate a contact, duplicate contact information, and complimentary contact information into a unified contact object. Duplicate contact information may be eliminated. Complimentary contact information may be integrated. Both duplicate and complimentary contact information may be determined according to match criteria.

A communication application may provide linking services at server 120. The application may be executed in the server 120 and provide linking services to a client 130 within client/server architecture. A server based communication application may provide continued connectivity to data sources. Continued network connectivity may enable a server based communication application to link retrieved contact information incrementally. An update in a data source may cause the communication application to propagate the update into a unified contact object upon an update determination according to match criteria. The communication application may eliminate determined duplicate contact information such as a duplicate email address. Additionally, the communication application may add complimentary contact information into the unified contact object such as an address not previously found in a contact.

Alternatively, the application may be executed solely in the client 130 in scenarios where server based architecture may be inconvenient. An example client based application may be a mobile device application providing the contact aggregation services with unreliable network connectivity. In such a scenario, aggregation services may be provided intermittently depended on available network connectivity. In a client based communication application, contact information may be synchronized intermittently with data sources.

In an embodiment, the communication application may retrieve contact information from different data sources. Data source 1 (110) to data source N (112) may host contact information. A data source may be an external or local data source. Data sources may include a variety of platforms such as social networking applications, partner applications, email services, address books and similar ones. Data sources may provide access to contact information through data services 114. The communication application may access the data services 114 through a data source connect application programming interface (API) 122. The application may utilize the data source connect API 122 to negotiate with the data services 114 in order to retrieve contact information hosted by data resources. The connect API may be part of services available in server 120. Alternatively the connect API may be a component of the communication application.

In an example scenario, the communication application may connect to the data service 114 of a social networking application utilizing the data source connect API 122 to retrieve a user's social networking contact information. Alternatively, the application may utilize the data source connect API 122 to retrieve contact information from an address book. The application may analyze the contact information to determine duplicate and complimentary contact information according to match criteria. Retrieved contact information may be duplicate contact information when some identifiers of a contact match some identifiers of the retrieved contact information. An example may be a name and email address of a retrieved contact information matching the contact's identifiers according to a match criteria of common name and email address.

In another example scenario, the application may determine the retrieved contact information as complimentary contact information when the retrieved contact information includes additional information not found in the contact. An example may be the complimentary contact information matching the contact according to a common name and email address match criteria and having a phone number not found in the contact.

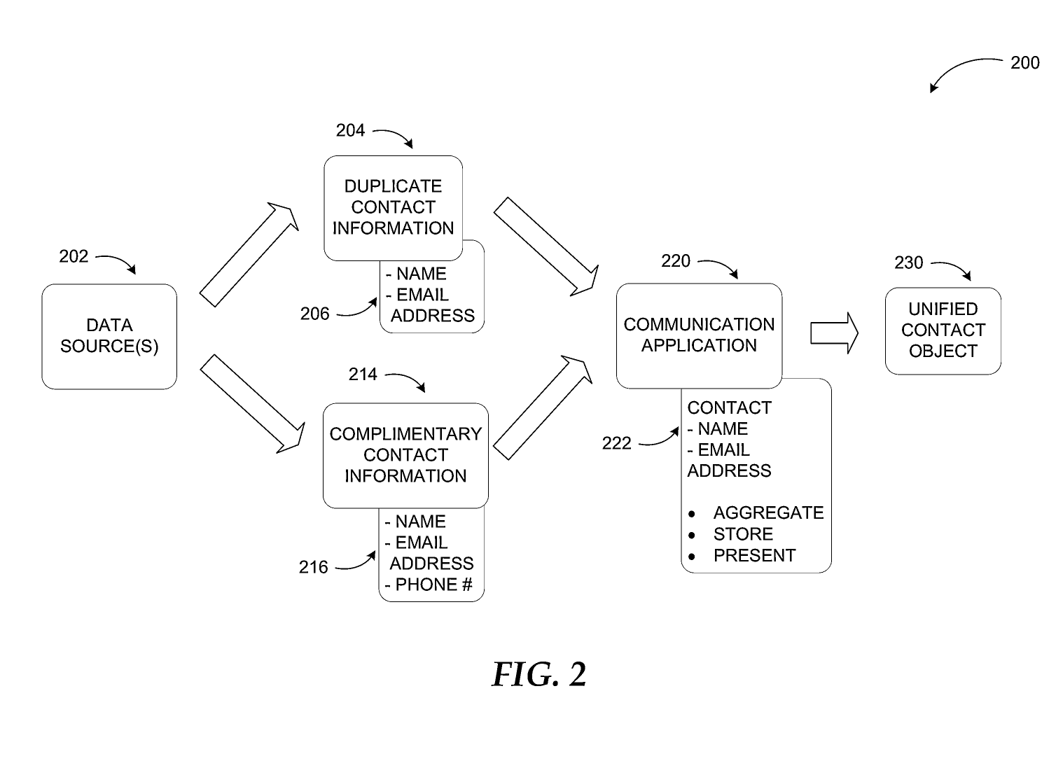

FIG. 2 illustrates major components of an application aggregating contact information into a unified contact object according to embodiments. Communication application 220 may retrieve contact information from data source 202. Data source 202 may be a single data source or may be multiple data sources as described above. Additionally, the data source may be external or local.

The communication application 220 may retrieve duplicate contact information 204. The duplicate contact information 204 may have identifiers 206 including name and email address in common with contact 222. The communication application may also retrieve complimentary contact information 214. The complimentary contact information may have identifiers 216 including name, email address and phone number.

The communication application 220 may provide aggregation, storage, and presentation functionality for contact 222. The contact may be an existing contact in a contact list used by the communication application. Alternatively, the contact may be a recently created contact.

The aggregation functionality may determine the retrieved contact information as duplicate or complimentary contact information according to common identifiers and aggregate the contact and the retrieved contact information into a unified contact object 230. Additionally, the application may provide storage functionality to maintain the unified contact object 230. The application may also provide the unified contact object 230 to other consuming applications.

The application may present the unified contact object through a user interface. A user may be enabled to access and edit the unified contact object through the user interface. The user interface may be scalable by providing a consistent experience across multiple platforms such as a desktop device based platform and mobile device based platform.

In an embodiment, the communication application may automatically link a contact with determined duplicate and complimentary contact information according to match criteria upon initial synchronization or import of data. The application may also be capable of subscribing to contact information in a data source to receive incremental updates on the subscribed contact information. The application may analyze the incremental update for duplicate and complimentary contact information to be linked with the unified contact. The schedule for retrieving updates may be according to an update timer setting of the subscription. The update timer setting may be user configurable.

In an example scenario, the application may detect a user edit or other operation adding, deleting, or changing identifiers in the subscribed contact information. Upon detecting the update operation (e.g.: an email address addition), the application may retrieve the subscribed contact information and analyze for duplicate or complimentary contact information between the unified contact object and the subscribed contact information. The application may link by eliminating duplicate contact information and integrating the complimentary contact information such as additional identifier information from the subscribed contact information into the unified contact object.

The application may also analyze for duplicate and complimentary contact information upon detecting an edit of the unified contact. The application may retrieve the subscribed contact information and aggregate any duplicate or complimentary subscribed contact information into the unified contact object subsequent to detecting the edit.

In another embodiment, the application may automatically link upon a manual user creation and editing of a contact. Upon a manual user creation of contact, the application may retrieve subscribed contact information from data sources and determine duplicate and complimentary contact information between the contact and the subscribed contact information. The application may link the subscribed contact information and the newly created contact information as described above. The application may then present the unified contact information through a user interface for viewing and editing by a user.

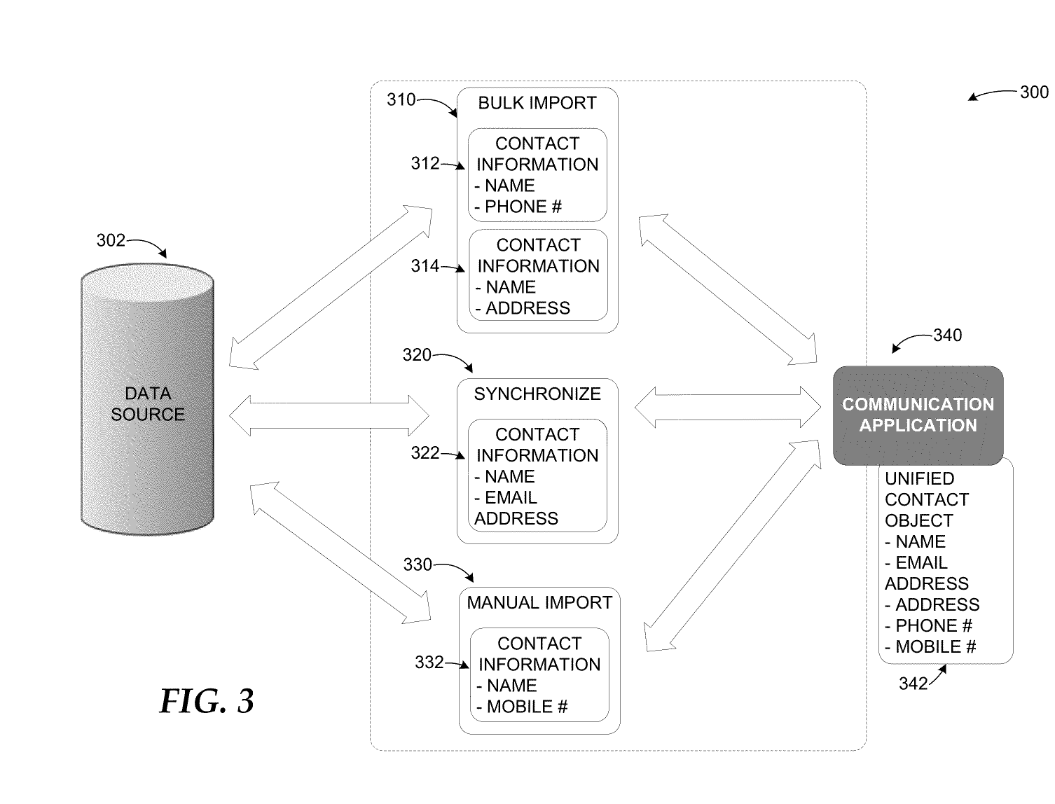

FIG. 3 illustrates example aggregation processes provided by a communication application in a system according to embodiments. Diagram 300 displays aggregation functionality across bulk import, synchronization, and manual import scenarios.

In a bulk import scenario 310, the communication application 340 may retrieve multiple contact information 312, 314 from data source 302. The application may retrieve contact information for all contacts or some of the contacts in data source 302 through a bulk import. The application may determine duplicate and complimentary contact information during the bulk import of multiple contacts. The application may eliminate duplicate contact information and add complimentary contact information to aggregate contact information retrieved during the bulk import into a unified contact object 342 for each contact. In an example scenario, the application may eliminate contact information upon determining duplicate contact information 314 according to match criteria of common name and email address. Additionally, the application may add phone number from contact information 312 into the unified contact object upon determining complimentary contact information of phone number according to match criteria of common name. The application may employ the bulk import to retrieve an initial set of contact information in a background process with minimal impact to a user experience.

In a synchronization scenario 320, the communication application may retrieve contact information matching a contact of the communication application according to match criteria. Synchronization may be as a result of a subscription process as discussed above. In an example scenario, the application may retrieve updated contact information from a data source upon detecting an update to subscribed contact information. The application may determine duplicate or complimentary contact information as described above. The application may determine duplicate contact information 322 according to match criteria of common name and email address. The application may eliminate the duplicate contact information and prevent entry of duplicate contact information 322 into the unified contact object 342.

A manual import scenario 330 may arise out of creation of a new contact. The application may automatically retrieve contact information from data source 302 upon detecting the creation of the contact. In an example scenario, the application may determine complimentary contact information 332 according to match criteria of common name. The application may add the mobile phone number from the complimentary contact information 332 to link the complimentary contact information 332 and the newly created contact.

In an embodiment, the communication application may employ a confidence algorithm to determine match criteria. The algorithm may use weighted elements of the duplicate and complimentary contact information such as common identifiers. The algorithm may assign a high weight score to a complete match of a common identifier. An example may be matching a name such as “Albert Lin” of a contact to a name such as “Albert Lin” of retrieved contact information. The algorithm may assign a low weight score to a partial match of a common identifier. An example may be matching a name such as “Albert Lin” of a contact to name such as “Al Lin” of retrieved contact.

In another embodiment, the algorithm may assign a high confidence score to one or more predefined or user selected identifiers of contact information (e.g., name, phone number, address, email address, organization, etc.). Matching contacts may be determined by comparing scores of candidate matching contacts against a threshold.

In yet another embodiment, the algorithm may be localizable and culture aware. The application may compare common identifiers in the match criteria through phonetic comparison to match the common identifiers in different languages. Additionally, the algorithm may be configurable to enable a user to define identifiers in match criteria. Examples may include matching names in different languages, shortened names, acronyms, etc. Thus, the weighting may be based on a predefined rule or user configuration.

In another embodiment, the application may provide the unified contact object to other consumers such as email servers. The application may provide the unified contact object to local communication applications through organizational interfaces. The application may provide the unified contact object to legacy application through customized interfaces. The application may provide the unified contact object to third party applications through standardized interfaces.

While the example communication applications, services, and platforms discussed in FIG. 1-3 may be an email service, embodiments may not be limited to an email service. Embodiments may be implemented in any application that facilitates real time or asynchronous communications such as Voice over Internet Protocol (VOIP) telephony, text messaging, video conferencing, application sharing, and comparable ones using the principles described herein.

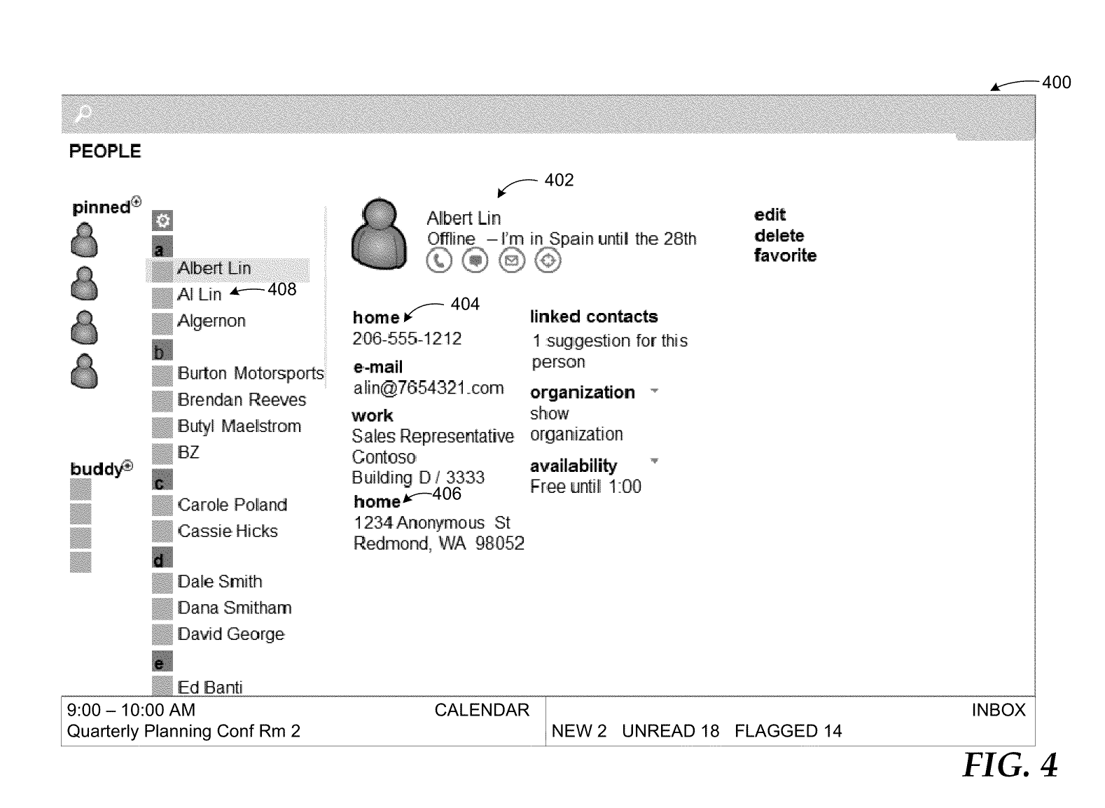

FIG. 4 illustrates an example user interface displaying unified contact object in a system according to embodiments. Diagram 400 illustrates a communication application user interface showing the unified contact object 402. The application presents contact information aggregate from a number of data sources through the user interface. The contact information in the unified contact object 402 includes the contact's identifier information such as name, phone numbers, email addresses, addresses, etc. Additionally, the contact information may include presence information such as contact's location and availability. In some embodiments, a source for particular contact information may be provided next to that contact information (also referred to as property) such that the user can easily understand which source the particular contact information (e.g., name, address, phone number, etc.) is coming from.

The application may determine duplicate and complimentary contact information according to match criteria of common identifiers as discusses above. The application may display the aggregated unified contact object 402. The application may aggregate the contact into a unified contact object by merging contact identifiers such as name and email address with complimentary contact information retrieved from data sources. Example identifiers include home phone number 404 and home address 406. The user interface may also show eliminated duplicate contact information 408. The user interface may indicate the duplicate contact information through an alert to inform the user in order to disregard the duplicate contact.

The above discussed user interface and example communication applications in FIG. 1-4 are for illustration purposes. Embodiments are not restricted to those examples. Other forms of automated contact information linking may be used by the application and presented in the user interface in a similar manner using the principles described herein.

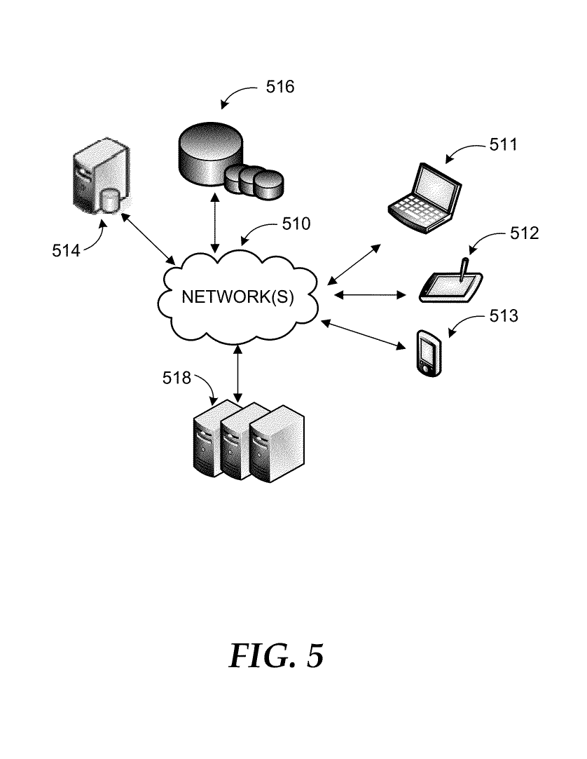

FIG. 5 is an example networked environment, where embodiments may be implemented. A communication application linkin contact and retrieved contact information may be implemented via software executed over one or more servers 518 such as a hosted service. The application may facilitate communications between client applications on individual computing devices such as a smart phone 513, a tablet computer 512, laptop computer 511, and a desktop computer (client devices') through network(s) 510.

As discussed, the communication application may access contact information from data sources through a variety of scenarios including, but not exclusive to, bulk import, synchronization, manual import. The communication application may determine duplicate or complimentary contact information according to match criteria of common identifiers between the retrieved contact information and contact. The application may eliminate duplicate contact information while aggregating contact and complimentary contact information into a unified contact object.

Client devices 511-513 are used to facilitate communications through a variety of modes between users of the communication application. One or more of the servers 518 may be used to manage contact information as discussed above. Contact information may be stored in one or more data stores (e.g. data store 516), which may be managed by any one of the servers 518 or by database server 514.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to automatically aggregate contact information. Furthermore, the networked environments discussed in FIG. 5 are for illustration purposes only. Embodiments are not limited to the example applications, modules, or processes.

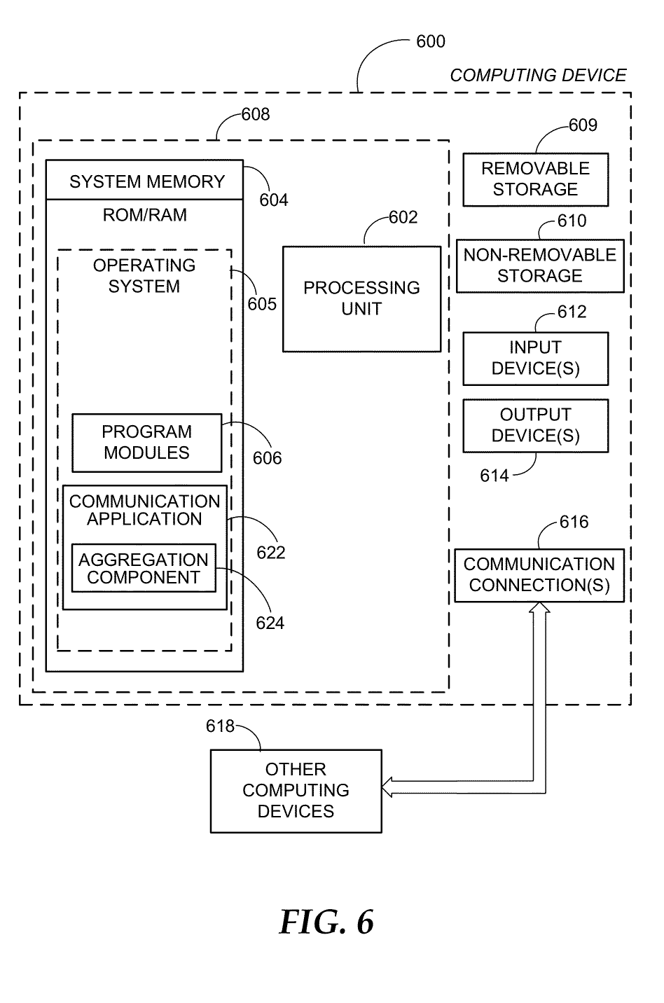

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a contact information linking device as part of a communication system and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS®, operating systems from MICROSOFT CORPORATION of Redmond, Wash. The system memory 604 may also include one or more software applications such as program modules 606, communication application 622, and aggregation component 624.

Communication application 622 may be part of a service that links contact information from a number of data sources for a variety of scenarios including bulk import, synchronization, and manual import. Aggregation component 624 may eliminate duplicate contact information and add complimentary contact information into the unified contact object. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

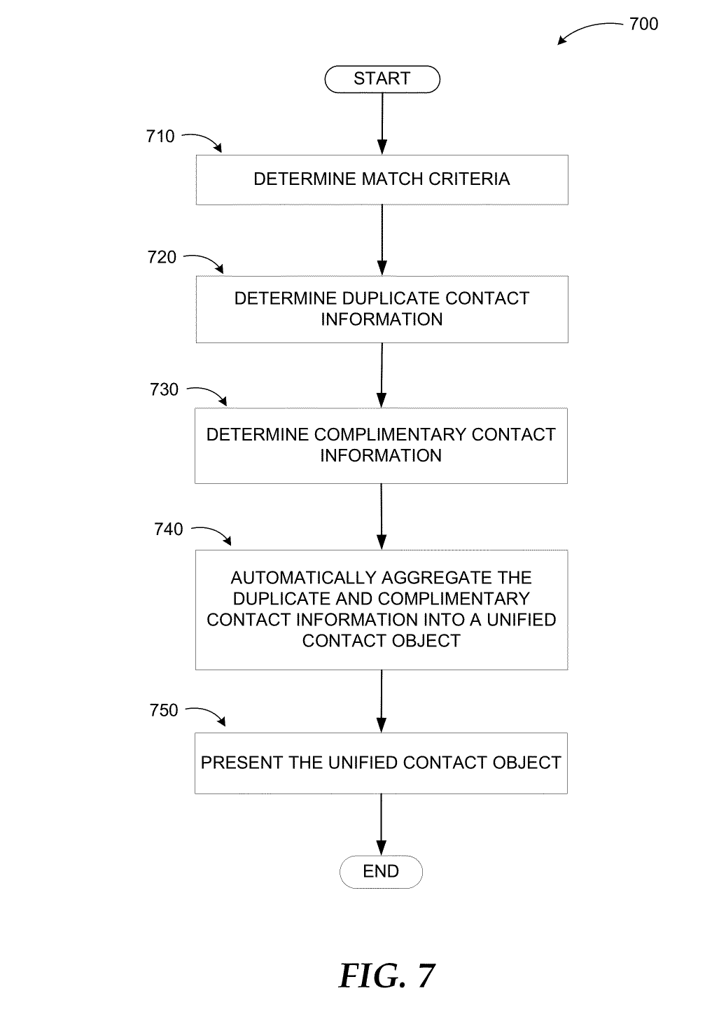

FIG. 7 illustrates a logic flow diagram for a process of automatically aggregating contact information according to embodiments. Process 700 may be implemented as part of a communication application that aggregates contact information.

Process 700 begins with operation 710, where the communication application determines a match criteria for a contact associated with a contact list of the communication application. Next, the communication application may determine duplicate contact information retrieved from at least one data service according to the match criteria at operation 720. The duplicate contact information may be retrieved from a data source including a social networking application, an email service, and an address book. The application may also determine complimentary contact information retrieved from another at least one data service according to the match criteria at operation 730. The determination may be according to common identifiers of match criteria between the potentially matching contact information and the original contact.

The application may automatically aggregate the duplicate and complimentary contact information and the original contact by eliminating the duplicate contact information and linking the complimentary contact information and the original contact at operation 740. At operation 750, the application may present a unified contact object representing linked contact information through a user interface of the communication application.

The operations included in process 700 are for illustration purposes. A communication application configured to automatically link contact information according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for automatically linking contact information, the method comprising:
determining match criteria for a contact associated with a contact list of a communication application;
determining matching contacts from at least one data source according to the match criteria;
automatically linking the matching contacts with the contact associated with the contact list by:
eliminating duplicate contact information, and
integrating complimentary contact information into a unified contact object; and
presenting the unified contact object through a user interface of the communication application.

2. The method of claim 1, further comprising:
employing a confidence based algorithm to implement the match criteria.

3. The method of claim 2, wherein employing the confidence based algorithm further comprises:
assigning scores to elements of the matching contacts in determining whether the matching contacts correspond to the contact associated with the contact list.

4. The method of claim 3, wherein the elements are weighted based on one of a predefined rule and a user configuration.

5. The method of claim 1, further comprising:
automatically linking the matching contacts with the contact upon one of an initial synchronization operation and an initial bulk import of contacts operation.

6. The method of claim 1, further comprising:
automatically linking the matching contacts with the contact through an incremental synchronization operation continuously.

7. The method of claim 1, wherein the matching contacts are determined and automatically linked at a server managing communication services.

8. The method of claim 1, wherein the matching contacts are determined and automatically linked client-side.

9. The method of claim 1, further comprising:
determining and automatically linking the matching contacts in response to one of: a manual creation of a new contact and a manual synchronization request.

10. The method of claim 1, further comprising at least one of:
employing phonetic comparison for matching one or more elements of contact information in determining the matching contacts; and
analyzing acronyms for matching one or more elements of contact information in determining the matching contacts.

11. The method of claim 1, further comprising:
employing an unlink action and an ignorance action history of past linking operations to avoid erroneous linking of contacts.

12. A communication server for automatically linking contact information, the server comprising:
a memory;
a processor coupled to the memory, the processor executing a communication application, wherein the communication application is configured to:
determine match criteria for a contact associated with a contact list of a communication application;
determine matching contacts from at least one data source according to the match criteria;
automatically link the matching contacts with the contact associated with the contact list upon one of an initial synchronization operation and an initial bulk import of contacts operation by:
eliminating duplicate contact information, and
integrating complimentary contact information into a unified contact object;
present the unified contact object through a user interface of the communication application; and
continue to automatically link the matching contacts with the contact through an incremental synchronization operation on an on-going basis.

13. The server of claim 12, wherein the at least one data source includes one or more of: a locally installed communication application data store, a hosted communication application data store, a legacy application data store, a custom data store, and a social network data store.

14. The server of claim 12, wherein the communication application includes one of: an email application, a text messaging application, a social networking application, and a multi-modal communication application.

15. The server of claim 12, wherein the communication application is further configured to:
subscribe to a contact information to retrieve an incremental update for the unified contact object.

16. The server of claim 15, wherein the communication application is further configured to:
retrieve an incremental update upon detecting a user edit of the subscribed contact information.

17. The server of claim 15, wherein the matching contacts are determined and automatically linked as a background process to reduce impact to a user experience.

18. A computer-readable memory device with instructions stored thereon for automatically aggregating contact information, the instructions containing:
determining match criteria for a contact associated with a contact list of a communication application;
determining matching contacts from at least one data source according to the match criteria;
automatically linking the matching contacts with the contact associated with the contact list at a server managing communication services upon one of an initial synchronization operation and an initial bulk import of contacts operation by:
eliminating duplicate contact information, and
integrating complimentary contact information into a unified contact object;
presenting the unified contact object through a user interface of the communication application; and
continuing to automatically link the matching contacts with the contact through an incremental synchronization operation on an on-going basis.

19. The computer-readable memory device of claim 18, wherein the instructions further comprise:
employing a confidence based algorithm to assign weighted scores to elements of the matching contacts in determining whether the matching contacts correspond to the contact associated with the contact list.

20. The computer-readable memory device of claim 18, wherein the instructions further comprise:
monitoring changes to existing contacts and new contacts in one or more data services to automatically link contact information in an asynchronous manner.
